(19) United States
(12) Patent Application Publication
(10) Pub. No.: US 2008/0274340 A1
(43) Pub. Date: Nov. 6, 2008

(54) NON-SPECULAR IRIDESCENT FILMS

(76) Inventor: Marc W. Giammatteo, Wappingers Falls, NY (US)

Correspondence Address: Cheng Song;BASF Corporation, 100 Campus Drive, Florham Park, NJ, 07932, US

(21) Appl. No.: 11/744,648

(22) Filed: May 4, 2007

(51) Int. Cl. B32B 7/02; B29C 47/06

(52) U.S. Cl. 428/213; 264/173.12

(57) ABSTRACT

A transparent thermoplastic resinous film of at least 10 generally parallel layers in which the contiguous adjacent layers are of diverse transparent thermoplastic material differing in refractive index by at least about 0.03, the planarity of the film being modified so as to reflect non-specular color. Modification of the film can be achieved by co-extruding an outer thermoplastic layer with the multilayer film which outer thermoplastic layer has a solidification temperature lower than the remaining film layers, cooling the film to modify the planarity thereof.

### BACKGROUND OF THE INVENTION

Multilayer plastic films, which contain alternating layers of two polymers of different refractive indexes, are iridescent when the individual layers are of suitable thicknesses. Such films are described in U.S. Pat. No. Re 31,780 to Cooper, Shetty and Pinsky, and U.S. Pat. No. 5,089,318 and U.S. Pat. No. 5,451,449, both to Shetty and Cooper which are hereby incorporated by reference, and other patents. Iridescent color is produced by the phenomenon of light interference. The pair of alternating polymer layers constitute the optical core. Usually, the outermost layers or skin layers are thicker than the layers in the optical core. This thicker skin may consist of one of the components in the optical core or may be a different polymer which is utilized to impart desired physical, mechanical or other properties to the film.

The multilayer films are composed of a plurality of generally parallel layers of transparent thermoplastic resinous material in which the contiguous adjacent layers are of diverse resinous material whose index of refraction differs by at least about 0.03. The film contains at least 10 layers and more usually at least 35 layers and, preferably, at least about 70 layers.

The individual layers of the film are very thin, usually in the range of about 30 to 500 nm, preferably about 50-400 nm, which causes constructive interference in light waves reflected from the many interfaces. Depending on the layer thickness and the refractive index of the polymers, one dominant wavelength band is reflected and the remaining light is transmitted through the film. The reflected wavelength is proportional to the sum of the optical thickness of a pair of layers.

The quantity of the reflected light (reflectance) and the color intensity depend on the difference between the two refractive indices, on the ratio of optical thicknesses of the layers, on the number of layers and on the uniformity of the thickness. If the refractive indices are the same, there is no reflection at all from the interfaces between the layers. In multilayer iridescent films, the refractive indices of contiguous adjacent layers differ by at least 0.03 and preferably by at least 0.06 or more. For first order reflections, reflectance is highest when the optical thicknesses of the layers are equal, although suitably high reflectances can be achieved when the ratio of the two optical thicknesses falls between 5:95 and 95:5. Distinct color reflections are obtained with as few as 10 layers. However, for maximum color intensity it is desired to have between 35 and 1,000 or even more layers. High color intensity is associated with a reflection band which is relatively narrow and which has high reflectance at its peak. It should be recognized that although the term “color intensity” has been used here for convenience, the same considerations apply to the invisible reflection in the ultraviolet and infrared ranges.

The multilayer films can be made by a chill-roll casting technique using a conventional single manifold flat film die in combination with a feedblock which collects the melts from each of two or more extruders and arranges them into the desired layer pattern. Feedblocks are described for instance in U.S. Pat. Nos. 3,565,985 and 3,773,882. The feedblocks can be used to form alternating layers of either two components (i.e. ABAB . . . ); three components (e.g. ABCABCA . . . or ACBCACBC . . . ); or more. The very narrow multilayer stream flows through a single manifold flat film die where the layers are simultaneously spread to the width of the die and thinned to the final die exit thickness. The number of layers and their thickness distribution can be changed in inserting a different feedblock module. Usually, the outermost layer or layers on each side of the sheet are thicker than the other layers. This thicker skin may consist of one of the components which makes up the optical core; may be a different polymer which is utilized to impart desirable mechanical, heat sealing, or other properties; or may be a combination of these.

Some recent developments in the iridescent film are described in U.S. Pat. Nos. Re. 31,780; 4,937,134; and 5,089,318. U.S. Pat. No. Re. 31,780 describes using a thermoplastic terephthalate polyester or copolyester resin as the high refractive index component of the system. Formation of elastomeric interference films are described in U.S. Pat. No. 4,937,134 in which all of the resinous materials are certain thermoplastic polyurethanes, polyester block amides or flexible copolyesters. U.S. Pat. No. 5,089,318 discloses improved multilayer light-reflecting transparent thermoplastic resinous film of at least 10 generally parallel layers in which the contiguous adjacent layers are of diverse transparent thermoplastic resinous material differing in refractive index by at least about 0.03 and at least one of the resinous materials being an engineering thermoplastic elastomer resin.

When a typical nanolayer iridescent film is measured for color on an integrating sphere spectrophotometer, the specular light must be included in the measurement, or no color will be measured at all (specular included instrument configuration). This is due to the design and the very nature of these film structures and the physics of light refraction and reflection. There are currently no commercially available nanolayer iridescent films in which the specular reflection color is visible off the specular angle.

### SUMMARY OF THE INVENTION

This invention is directed to novel iridescent films in which the specular reflection color is visible off the specular angle. This allows for applications and appearances that were previously unattainable with the prior art iridescent films.

The novel optical effect is achieved by a modification to the surface and/or the entire structure of multilayer plastic films, which contain alternating layers of two polymers of different refractive indexes and that are known in the art. The modification, believed to be a change in planarity of the juxtaposed layers of the film, changes the angle of light both as it enters and as it exits a typical nanolayer iridescent film structure. This modification redirects the constructive interference portion of the reflection away from the specular angle/specular gloss portion of the reflection. Several methods of modifying the multilayered films are provided.

### DETAILED DESCRIPTION OF THE DRAWINGS

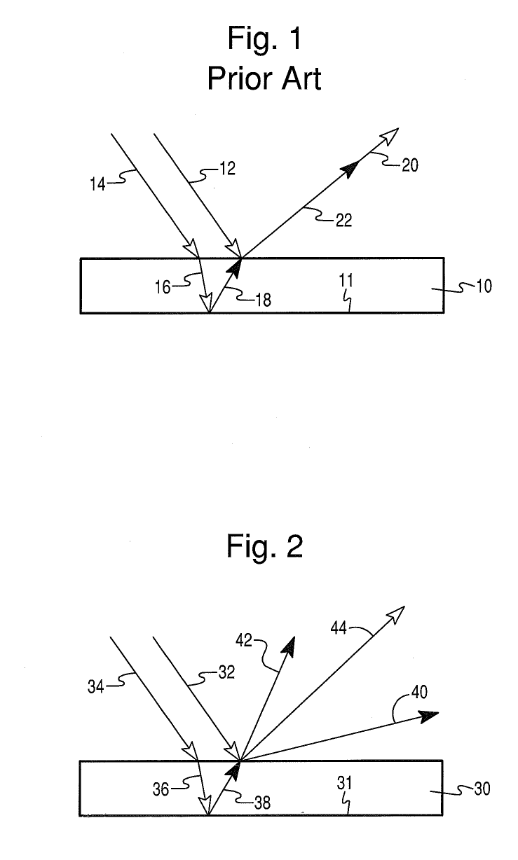

FIG. 1 is a schematic showing the reflectance characteristics of a prior art multilayer iridescent film.

FIG. 2 is a schematic showing the reflectance characteristics of the iridescent film of the present invention.

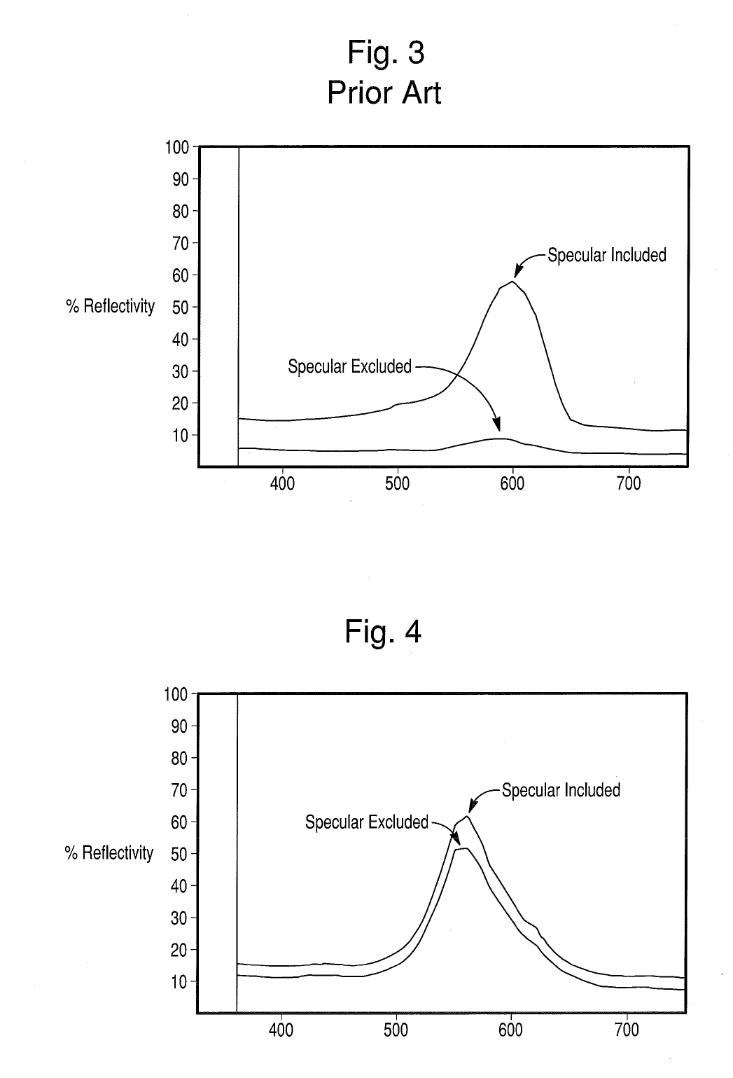

FIG. 3 is a measurement of light reflected off prior art iridescent film.

FIG. 4 is a measurement of light reflected off the iridescent film of the present invention.

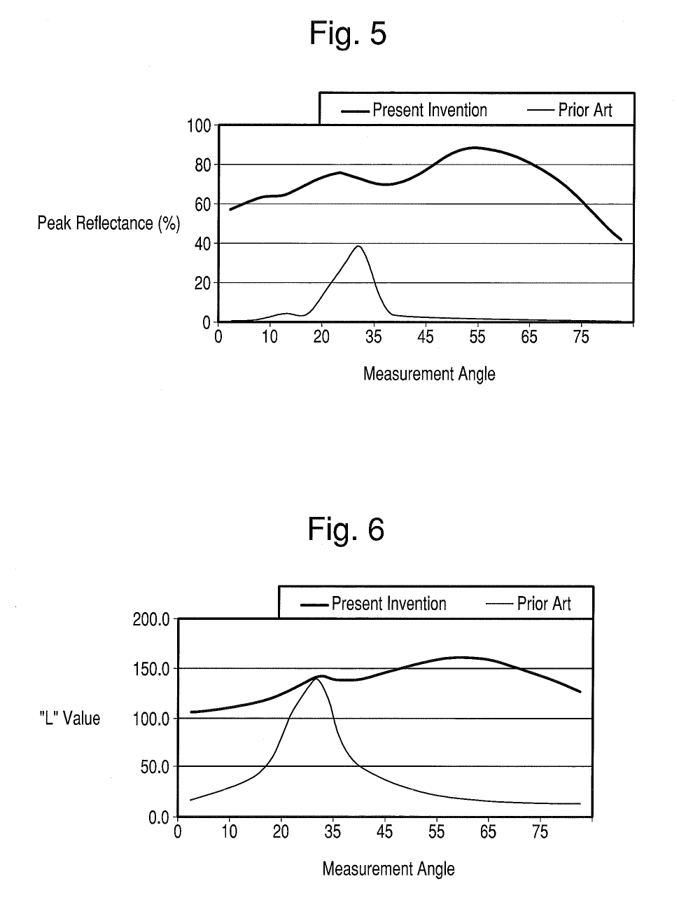

FIG. 5 is a measurement of light reflected off the prior art iridescent film and the iridescent film of the present invention with an illuminant fixed at a 25° angle.

FIG. 6 is a measurement of the L valve as a function of measurement angle from the prior art iridescent film and the iridescent film of the present invention.

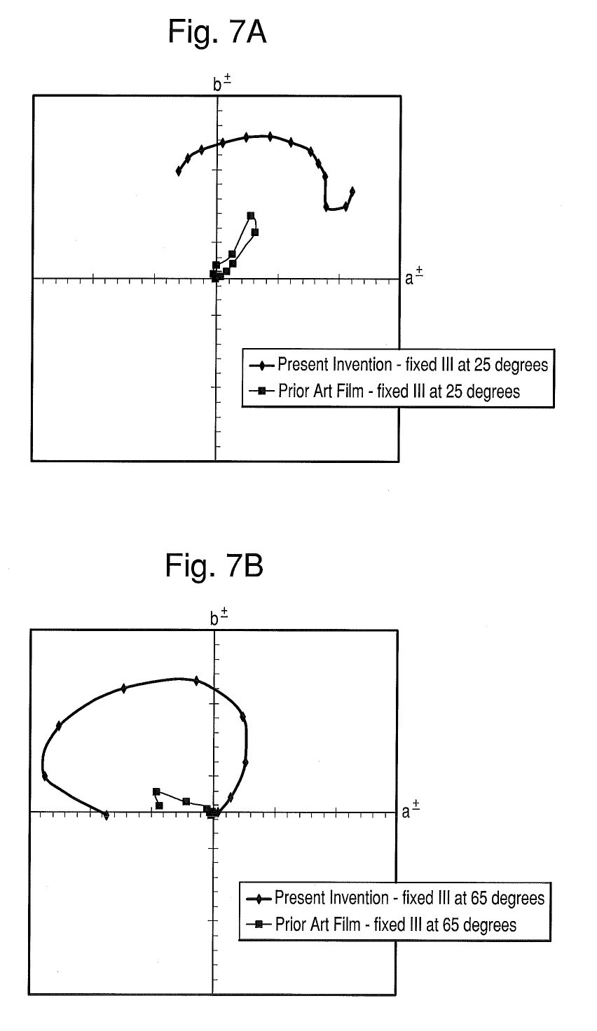

FIG. 7a is a 2-dimensional plot of the chromaticity values a and b for the prior art iridescent film and the iridescent film of the present invention with the illuminate fixed at a 25° angle.

FIG. 7b is a 2-dimensional plot of the chromaticity values a and b for the prior art iridescent film and the iridescent film of the present invention with the illuminate fixed at a 65° angle.

### DETAILED DESCRIPTION OF THE INVENTION

The present invention is applicable to all of the iridescent multilayer films that heretofore exist. Such films are composed of a plurality of generally or substantially parallel layers of transparent thermoplastic resinous material in which the contiguous adjacent layers are of diverse resinous materials whose index of refraction differs by at least about 0.03 and, preferably, at least 0.06. These films contain at least 10 layers, or usually at least 35 layers, and preferably at least 70 layers. The individual layers of resinous materials in the film are very thin, usually in the range of about 30 to 500 nm, and preferably about 50 to 400 nm.

The multilayer films are usually made by a chill-roll casting technique in which melts of the thermoplastic resinous material from two or more extruders are collected by a feedblock which arranges them into a desired layered pattern. The very narrow multilayer stream flows through a single manifold flat film die with the layers simultaneously spread to the width of the die and thinned to the final die exit thickness. The number of layers and their thickness distribution can be changed by using a different feedblock module. Usually, the outermost layer or layers on each side of the sheet is thicker than the other layers so as to form a relatively thick skin. The resinous material used to form the skin may be one of the components which makes up the optical core, or a different polymer which is utilized to impart a desirable mechanical, heat sealing or other property, or a combination of these.

Specific examples of suitable materials which provide the layers of the iridescent film include polyethylene naphthalate (PEN) and isomers thereof (e.g., 2,6-, 1,4-, 1,5-, 2,7-, and 2,3-PEN), polyalkylene terephthalates (e.g., polyethylene terephthalate, polybutylene terephthalate, and poly-1,4-cyclohexanedimethylene terephthalate), polyimides (e.g., polyacrylic imides), polyetherimides, atactic polystyrene, polycarbonates, polymethacrylates (e.g., polyisobutyl methacrylate, polypropylmethacrylate, polyethylmethacrylate, and polymethylmethacrylate), polyacrylates (e.g., polybutylacrylate and polymethylacrylate), syndiotactic polystyrene (sPS), syndiotactic poly-alpha-methyl styrene, syndiotactic polydichlorostyrene, copolymers and blends of any of these polystyrenes, cellulose derivatives (e.g., ethyl cellulose, cellulose acetate, cellulose propionate, cellulose acetate butyrate, and cellulose nitrate), polyalkylene polymers (e.g., polyethylene, polypropylene, polybutylene, polyisobutylene, and poly(4-methyl)pentene), fluorinated polymers (e.g., perfluoroalkoxy resins, polytetrafluoroethylene, fluorinated ethylene-propylene copolymers, polyvinylidene fluoride, and polychlorotrifluoroethylene), chlorinated polymers (e.g., polyvinylidene chloride and polyvinylchloride), polysulfones, polyethersulfones, polyacrylonitrile, polyamides, silicone resins, epoxy resins, polyvinylacetate, polyether-amides, ionomeric resins, elastomers (e.g., polybutadiene, polyisoprene, and neoprene), and polyurethanes. Also suitable are copolymers, e.g., copolymers of PEN (e.g., copolymers of 2,6-, 1,4-, 1,5-, 2,7-, and/or 2,3-naphthalene dicarboxylic acid, or esters thereof, with (a) terephthalic acid, or esters thereof, (b) isophthalic acid, or esters thereof; (c) phthalic acid, or esters thereof; (d) alkane glycols; (e) cycloalkane glycols (e.g., cyclohexane dimethane diol); (f) alkane dicarboxylic acids; and/or (g) cycloalkane dicarboxylic acids (e.g., cyclohexane dicarboxylic acid)), copolymers of polyalkylene terephthalates (e.g., copolymers of terephthalic acid, or esters thereof, with (a) naphthalene dicarboxylic acid, or esters thereof; (b) isophthalic acid, or esters thereof; (c) phthalic acid, or esters thereof; (d) alkane glycols; (e) cycloalkane glycols (e.g., cyclohexane dimethane diol); (f) alkane dicarboxylic acids; and/or (g) cycloalkane dicarboxylic acids (e.g., cyclohexane dicarboxylic acid)), and styrene copolymers (e.g., styrene-butadiene copolymers and styrene-acrylonitrile copolymers), 4,4′-bibenzoic acid and ethylene glycol. In addition, each individual layer may include blends of two or more of the above-described polymers or copolymers (e.g., blends of sPS and atactic polystyrene). The coPEN described may also be a blend of pellets where at least one component is a polymer based on naphthalene dicarboxylic acid and other components are other polyesters or polycarbonates, such as a PET, a PEN or a co-PEN.

Thermoplastic elastomers (TPE) can be used as one of the resinous materials. Such materials are copolymers of a thermoplastic hard segment such as polybutyl terephthalate, polyethylene terephthalate, polycarbonate, etc., and a soft elastomeric segment such as polyether glycols, silicone rubbers, polyetherimide and the like. Changing the percentage of the soft elastomer segment will result in thermoplastic elastomers having different refractive indexes. It is thus possible to have a thermoplastic elastomer copolymer which differs in refractive index from the base hard segmented thermoplastic polymer by greater than 0.03. It is also possible to obtain two TPE's with the same hard and soft segments but with a difference in refractive index of greater than 0.03 where the only difference between the two TPE's is the amount of the soft elastomeric segments in the copolymer.

The thermoplastic elastomers are preferably segmented thermoplastic copolyesters containing recurring long chain ester units derived from dicarboxylic acids and long chain glycols and short chain ester units derived from dicarboxylic acids and low molecular weight diols.

The long chain glycols are polymeric glycols having terminal (or as nearly terminal as possible) hydroxide groups and a molecular weight above about 400 and preferably from about 400 to 4,000. They can be poly(alkylene oxide) glycols such as, for example, poly(ethylene oxide) glycol, poly(propyl oxide) glycol, poly(tetramethalene oxide) glycol and the like.

The short chain ester unit refers to low molecular weight compounds or polymer chain units having molecular weights of less than about 550. They are made using a low molecular weight diol (below about 250) such as ethylene diol, propylene diol, butanediol, etc., or equivalent ester forming derivatives such as ethylene oxide or ethylene carbonate for ethylene glycol, with a dicarboxylic acid to form ester units.

The dicarboxylic acids are aliphatic, cycloaliphatic or aromatic dicarboxylic acids of low molecular weight, i.e., having a molecular weight of less than about 300. Examples include terephthalic acid, isophthalic acid, naphthalene dicarboxylic acid, cyclohexane dicarboxylic acid, adipic acid, succinic acid, oxalic acid and the like.

The segmented thermoplastic copolyester elastomers are well known in the art and are described, for example, in U.S. Pat. Nos. 3,651,014, 3,763,109, 3,766,146 and 3,784,520, the disclosures of which are incorporated herein by reference.

The essential feature of this invention is a modification to the surface and/or the entire multilayered film structure that changes the angle of light both as the light enters and as the light exits a typical nanolayer iridescent film structure. The modification appears to be a change in the planarity or “wrinkling” of the contiguous layers which form the film. The modified structure redirects the constructive interference portion of the reflection away from the specular angle/specular gloss portion of the reflection. The film produced by this invention is characterized by a measurement of bright reflection color even when measured without the specular light included, and when measured off the specular angle (as can be seen when color readings are taken with a goniospectrophotometer, see, e.g., Example 1). In other words, the film of the present invention results in a substantial non-specular reflection of light (i.e., light reflected off the specular angle). As used herein, a “substantial non-specular reflection of light” is at least 30%, at least 40%, at least 50%, or at least 75% of the specular light reflected, when measured with an integrating sphere spectrophotometer in the specular excluded instrument configuration as compared to the same sample measured in the specular included configuration.

The iridescent film of this invention creates a ‘glowing’ color effect never before seen with iridescent film as it is known in the art. By moving the iridescent specular color away from the specular angle, the intense iridescent color can now be seen at many different angles without the interference of the specular light source. The specular light source reduces the perceived color intensity of prior art films by overpowering the iridescent color. The modified film of this invention has greatly increased perceived color intensity. Further, the films of this invention can be treated by metalization and still retain iridescent color, which is almost always eliminated with prior art iridescent film structures. This in turn allows for iridescent decorative structures to be produced that possess the physical properties associated with metalization, such as barrier resistance, as well as the decorative properties, such as mirror-like reflection.

Referring now to FIGS. 1 and 2, the differences in the reflectance characteristics of a prior art multilayer iridescent film and the modified multilayer film of this invention can be described. In FIG. 1, a prior art multilayer iridescent film is indicated by reference numeral 10. Incident light being directed onto film 10 is indicated by arrows 12 and 14. The incident light as indicated by arrow 14 is bent as indicated by reference numeral 16 as light travels through the transparent film 10 due to the different refractive indexes between the contiguous individual layers of the film. Light is reflected off an interface 11 between two of the contiguous layers of film 10 as indicated by reference numeral 18 and is directed as reflected color from the surface of film 10 as indicated by arrow 22. This reflected light indicated by arrow 22 provides the iridescent color of film 10. Unfortunately, incident light as indicated by reference numeral 12 is reflected off the surface of film 10 as a mirror image reflection of the light source as indicated by reference numeral 20. This specular gloss as indicated by reference numeral 20 from the surface of film 10 mixes with the iridescent color, as indicated by reference numeral 22, which is directed from the film also at the specular angle of the incident light. The specular gloss from light 20 washes out or dulls the color of reflected light 22. No colored light is reflected from film 10 off of the specular angle.

FIG. 2 illustrates the reflectance characteristics of an iridescent film that has been modified in accordance with the processes of the present invention as more fully described below. In FIG. 2, the modified iridescent film is generally indicated by reference numeral 30. Incident light is indicated by reference numerals 32 and 34. Light contacting the film as indicated by arrow 34 is bent as it passes through the film, again due to the differences in the refractive index of the contiguous individual layers that make up film 30. The redirection of the incident light from arrow 34 through film 30 is shown by arrow 36. The light from arrow 36 is then reflected off interface 31 between contiguous layers of film 30, as indicated by reference numeral 38, and is reflected as color from the surface of film 30 as shown by arrows 40 and 42. In the film of the present invention, the iridescent reflected color as indicated by arrows 40 and 42 is displaced from the specular angle. This leaves the iridescent color, as indicated by reference arrows 40 and 42, appearing incredibly deep, rich, and intense, as such color is not washed out by the specular light reflected as gloss from the surface of film 30, as indicated by arrow 44, from incident light 32.

The novel iridescent film of this invention and the particular reflectance of color achieved can be accomplished by several processes. In each of the processes, it is believed that not only is the surface of the film modified, but that the modification goes deeper into the film from the surface. If the processes of the invention only modified the surface of the film, it is believed that once the film was laminated to a surface, the wrinkling or other planar imperfections in the surface would be filled in by the adhesive used to laminate the film to another surface and the effect would be eliminated. Even if the film of this invention is laminated to another surface, the unusual and novel color effects of the film are still seen. Accordingly, the disruption of the planarity of the film must extend beyond the surface thereof, and not present as minor surface imperfections.

The preferred method of modifying an iridescent multilayer film so as to achieve the unique reflective characteristics which have been found by this invention is to process the film during the co-extrusion of the film layers through a desired feedblock as described previously and as set forth in U.S. Pat. No. 3,565,985 and U.S. Pat. No. 3,773,882, mentioned above and which are herein incorporated by reference. In accordance with this aspect of the invention, an outer or skin layer is melted and co-extruded with the other layers of the film through a flat film die. The skin layer has a substantially different solidification temperature than at least one of the layers which form the core of the multilayer film. Thus, in accordance with this invention, during the co-extrusion process, a skin layer is co-extruded with the other multilayers which form the core of the film and wherein the skin layer is incompatible with at least one of the core multilayers of the film. The term “incompatible” as used herein means that the skin layer has a substantially different solidification temperature and typically solidifies at a lower temperature than at least one of the other layers. For example, a multilayer film formed from various polyesters such as a film formed from alkylene terephthalate or acrylic and/or methacrylic acid esters would have a substantially different solidification temperature during cooling than a polyolefin layer.

After the skin layer is co-extruded with the other multiple layers which form the iridescent film of this invention, the extruded film is then directed to the chill roll in which the incompatible skin layer contacts the chill or cast roll. It is very useful if the cast roll temperature is at a temperature of 30-80° F. cooler than the normal cooling temperature for the optical core polymers used. For example, if a PBT skin layer is co-extruded with a core film containing alternating layers of polybutylene terephthalate and polymethylenethacrylate, the typical cooling temperature is about 160-180° F. In accordance with this invention, cooling of a multilayer film which contains a polyethylene skin layer on one side of the PBT/PMMA core film would be from about 90-100° F. Since the polyethylene layer solidifies at a lower temperature and, thus, at a faster rate than the materials which form the other layers of the multilayer film, there is formed some type of wrinkling or planar distortion not only at the film surface which contacts the skin layer, but the distortion appears to exist well below the surface and even through about the entire film. To achieve the best results at disrupting the planarity of the film, the solidification temperature between the co-extruded skin layer and the solidification temperature of the remaining layers that form the multilayer film should be substantially different. As used herein “substantially different” means the solidification temperature of the co-extruded skin layer should be at least about 25% lower than the solidification temperature used to form the core layers. Solidification temperatures for the co-extruded skin layer of at least 40% lower than the core layers are also exemplified.

In the case where the skin layer is physically incompatible with the remaining layers of the multilayer film such that the skin layer would readily delaminate from the core of the film with time, it is useful to remove the skin layer from the core film after the film is cooled. Once the skin layer is removed, the remaining core film can be used in any article in which iridescent films have previously been used. The films which are formed by the method of this invention can be further laminated to any suitable substrate and used in any application that currently employs iridescent film. The improvement in the perceived brighter iridescent and maximum color intensity, and the wider viewing angle of said color, can greatly improve the decorative effects of the present film over the prior art films. The incompatible skin layer of this invention can remain laminated to the core film if in fact the incompatible skin layer is physically and chemically compatible with the multilayers of the core film. Thus, it may be that a particular polyester film can be used as the skin layer which has a substantially faster solidification time than the remaining polyester layers of the core film.

It has been found that for the above method for producing iridescent films which reflect non-specular color, the effect often times is directional. For example, by turning a film that shows bright, intense non-specular color 90° with respect to the incident light, the non-specular color reflection is eliminated.

Several other methods are believed to be useful in achieving the planar disruption of the multilayer films known in the art. These other methods, however, may have some disadvantages that are not present in the above-described method. Thus, in the above-described method, the distortion of the film is actually achieved during the normal extrusion and cooling process of the multilayer film. The methods described immediately below, however, are post-treatment steps in which a formed and solidified multilayer film is subsequently processed. This subsequent processing may add substantial costs to the film-making process.

In one of these alternative processes for disrupting the planarity of the multilayer film and affecting the optical properties thereof, a co-extruded multilayer film as formed in the prior art is directed into a solvent bath, which solvent is incompatible with at least one of the multilayers which form the core film. In this method, it is believed that the solvent swells or otherwise disrupts a portion of the multilayer film to permanently disrupt the film to yield the iridescent off-specular color of the films of this invention. Thus, it has been found that certain polyester-based films such as formed from PEN and other polyesters such as PBT and the like, when treated in trichloroethylene, and films formed from EVA and other polyesters when treated in methylethylketone, can yield off-specular iridescent color. Obviously, the use of organic solvents and, again, the subsequent post-treatment process may render such method impractical for cost and/or even safety reasons.

In another alternative method, a formed multilayer film such as known in the prior art is heated in an oven under exact conditions to cause different shrinkage rates between the alternating and contiguous film layers and, again, causing a wrinking or other planar distortion at the surface and through the core film. Some film formations can be heated via a series heated rollers to cause the planar distortion. Again, these methods involve concise and often lengthy post-operative method steps that can add to the cost of the film. Further, it is not always clear that this method provides consistent results and, although it is disclosed as a method for achieving the off-specular iridescent color of the present invention, it is not a preferred method of achieving the unique properties of the films of this invention. In both the solvent treatment method or the post-heating method, it is important that the film is not at high tension while being treated, but is loosely arranged within the solvent or within a heating oven, or includes a substantial slack around a plurality of heating rollers.

### EXAMPLE 1

A comparison of light reflectivity of a prior art multilayer iridescent film and a film formed by the method of the present invention was made. Both films contained a core of 113 alternating layers of polybutylene terephthalate and polymethylmethacrylate. The prior art film also contained a thicker PBT skin on both opposing surfaces of the core. The standard film was formed by the co-extrusion process described previously and the co-extruded film roller-cooled at about 170° F. The film of the present invention was also formed by the same co-extrusion process, except that the PBT skin layers were not co-extruded with the 113 layer core. Instead, a polyethylene layer was co-extruded on only one side of the core such that only one surface of the core contained the polyethylene layer. The co-extruded film was roller-cooled at 90° F. such that only the polyethylene skin contacted the roller. Upon solidification, the polyethylene skin was delaminated from the core and removed from the final film.

The light reflected from each film was measured with an integrating sphere spectrophotometer in both the specular included and specular excluded instrument configurations and the results are graphed in FIG. 3 for the standard prior art film and FIG. 4 for the film of this invention. As shown in FIG. 3, when the specular reflected light is excluded from the measurement, there is only minor amounts of off-specular light that is reflected. Thus, in the prior art film, the non-specular reflection was only 15% of the specular light reflected. On the other hand, the film of the present invention yielded a bright, intense, off-specular color. Measurements indicated that the reflectivity of the off-specular color was 84% of the specular light reflected.

Measurements were also taken for each film using a goniospectrophotometer. The film of this invention exhibits strong reflection when measured off the specular angle. The goniospectrophotometer measurements were taken with the illuminate held constant at 25° while the sensor was moved from 0° to 80° in 5° increments. Standard film of the prior art exhibits strong reflectance only in a narrow range around 25° (the specular angle), while film of the current invention shows strong reflectance from about 0° to about 70°, as seen in FIG. 5. Chromaticity values L, a, and b also remain high through this range of measurement angles. L values are plotted as a function of measurement angle in FIG. 6. FIG. 7 is a 2 dimensional plot of the chromaticity values a and b. It can be seen that the color data for films of the prior art quickly return to 0 when the measurement angle moves away from the specular angle while films of the current invention retain strong color values throughout the measurement range. Additional measurements were taken using the same technique with the illuminant held constant at 0°, 45°, and 65°. Similar data was obtained for these measurements; that is to say that the film of the present invention retains strong color reflections away from the specular angle. This describes numerically the very wide observation window of the iridescent color for films of the current invention.

From the forgoing description, one skilled in the art can easily ascertain the essential characteristics of this invention, and without departing from the spirit and scope thereof, can make various changes and modifications to the invention to adapt it to various usages and conditions.

What is claimed is:

1. A transparent thermoplastic resinous laminate film of at least 10 very thin layers of substantially uniform thickness of about 30 to 500 nm, said layers being substantially parallel and the contiguous adjacent layers being of different transparent thermoplastic resinous materials, the contiguous adjacent layers differing in refractive index by at least about 0.03, said film having a non-specular color reflection of at least 30% of the specular light reflected.

2. The transparent thermoplastic resinous laminate film of claim 1 wherein said contiguous adjacent resinous layers differ in refractive index by at least about 0.06.

3. The transparent thermoplastic resinous laminate film of claim 1 wherein one of the thermoplastic resinous materials is polyethylene terephthalate or polybutylene terephthalate.

4. The transparent thermoplastic resinous laminate film of claim 3 wherein one of the thermoplastic resinous materials is polymethyl methacrylate.

5. The transparent thermoplastic resinous laminate film of claim 4 including an outer layer of a polyolefin.

6. The transparent thermoplastic resinous laminate film of claim 1 wherein said film has a non-specular color reflection of at least 50% of the specular light reflected.

7. The transparent thermoplastic resinous laminate film of claim 1 wherein said film has a non-specular color reflection of at least 75% of the specular light reflected.

8. A transparent thermoplastic resinous laminate film of at least 10 very thin layers of substantially uniform thickness of about 30 to 500 nm, said layers being generally parallel and the contiguous adjacent layers being of different transparent thermoplastic resinous materials, the contiguous adjacent layers differing in refractive index by at least about 0.03, said film being formed by co-extruding with said thin layers, an outer incompatible layer of a thermoplastic resin on one surface of said film, said outer layer of said thermoplastic resin having a solidification temperature (° F.) at least 25% lower than the solidification temperature of at least one of said thin layers, cooling said co-extruded film whereby the different solidification temperatures of said outer layer and said at least one thin layer disrupts the planarity of said laminate film such that said laminate film reflects non-specular color.

9. The laminate film of claim 8 wherein said co-extruded film is cooled by contacting only said outer film with a cooling roller.

10. The laminate film of claim 8 wherein said outer layer has a solidification temperature at least 40% lower than the solidification temperature of said at least one thin layer.

11. The laminate film of claim 8 wherein one of the thermoplastic resinous materials is polyethylene terephthalate or polybutylene terephthalate.

12. The laminate film of claim 11 wherein one of the thermoplastic resinous materials is polymethyl methacrylate.

13. The laminate film of claim 12 wherein said outer layer is a polyolefin.

14. The laminate film of claim 8 wherein said outer layer is delaminated from said laminate film after said cooling.

15. A method of producing a transparent thermoplastic resinous laminate film of at least 10 very thin layers of substantially uniform thickness of about 30 to 500 nm, said layers being substantially parallel and the contiguous adjacent layers being of different transparent thermoplastic resinous materials, the contiguous adjacent layers differing in refractive index by at least about 0.03, said method comprising co-extruding with said thin layers, an outer layer of a thermoplastic resin on one surface of said film, said outer layer of said thermoplastic resin having a solidification temperature (° F.) substantially different than the solidification temperature of at least one of said thin layers, cooling said co-extruded films whereby the different solidification temperatures of said outer film and said at least one thin layer disrupts the planarity of said laminate film.

16. The method of claim 15 wherein said outer layer has a solidification temperature at least 25% lower than the solidification temperature of said at least one thin layer.

17. The method of claim 16 wherein said outer layer has a solidification temperature at least 40% lower than the solidification temperature of said at least one thin layer.

18. A method of producing a transparent thermoplastic resinous laminate film of at least 10 very thin layers of substantially uniform thickness of about 30 to 500 nm, said layers being substantially parallel and the contiguous adjacent layers being of different transparent thermoplastic resinous materials, the contiguous adjacent layers differing in refractive index by at least about 0.03, said method comprising co-extruding said different transparent thermoplastic resinous materials into said laminate film, and treating said film with a solvent which is incompatible with at least one of said thin layers or said materials having different shrinkage rates upon heating and heating said film to control the shrinkage rate of said material, such as to disrupt the planarity of said laminate film.

19. The method of claim 18, wherein said solvent treatment is with trichloroethylene or methylethylketone.

20. The method of claim 18, wherein said film is heated in an oven or with a series of heated rollers.
